(19) United States
(12) Patent Application Publication
(10) Pub. No.: US 2010/0020653 A1
(43) Pub. Date: Jan. 28, 2010

(54) Optical Disc Apparatus and Method for Recording Information Using the Same

(75) Inventors: Mitsunori Kobayashi, Chigasaki (JP); Tetsuya Fushimi, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 12/420,329

(22) Filed: Apr. 8, 2009

(30) Foreign Application Priority Data
Jul. 25, 2008 (JP) 2008-192410

(51) Int. Cl. G11B 20/10

(52) U.S. Cl. 369/47.5; G9B/20.009

(57) ABSTRACT

This invention provides an optical disc apparatus constructed to discriminate a disc ID of an optical disc on which information is to be recorded, then derive, from a strategy pre-registered in the optical disc apparatus, test-recording repetition count information that matches the discriminated disc ID, and after using the derived test-recording repetition count information to assign the number of test-recordings to be conducted upon one specific address within a test-recording area of the optical disc, implement the assigned number of test-recordings and calculate an optimum recording power level for information recording, based upon a read signal generated after the final test-recording. The above construction improves recording power accuracy of information recording on rewritable optical discs.

### CLAIM OF PRIORITY

The present application claims priority from Japanese patent application serial No. P2008-192410, filed on Jul. 25, 2008, the content of which is hereby incorporated by reference into this application.

### BACKGROUND

1. Technical Field

The present invention relates generally to techniques for recording information by an optical disc apparatus, and more particularly, to a technique for conducting an Optimum Power Control (OPC) processing upon a rewritable optical disc.

2. Description of the Related Art

Some of conventional optical disc apparatuses perform recording laser power setup before information recording as shown in FIG. 7 when, for example, information is recorded on a rewritable optical disc such as a CD-RW and DVD-RW. First, a test-recording (Power Scan Write) based on the test-recording power that is gradually increased in level is conducted once in the test-recording area (commonly known as the power calibration area) of the optical disc (step S701). Next, the written information is read out from the disc (step S702), the modulation characteristics (Mod characteristics) of the read signal are calculated (step S703), and gamma characteristics (γ-characteristics) are calculated from the modulation characteristics (step S704). After this, a target recording power level is calculated from the gamma characteristics, and then the optimum recording power level for information recording is calculated and set based on the target recording power level (step S705). FIG. 8A is an example of the read signal characteristics obtained in such an optical disc apparatus, showing its read signal level that varies according to the recording power level Pw. In the figure, eₜₒₚ denotes the top envelope value of the read signal level, e_{DC} denotes the DC value of the read signal level, and e_{btm} denotes the bottom envelope value of the read signal level. Each coordinate point represents where the above values are actually measured. FIG. 8B shows an example of the modulation characteristics (Mod characteristics) of a read signal calculated from the read signal characteristics of FIG. 8A and an example of the gamma characteristics (γ-characteristics) calculated from the modulation characteristics (Mod characteristics). The modulation characteristics (Mod characteristics) are calculated from a equation: Mod=(eₜₒₚ−e_{btm})/eₜₒₚ, and the gamma characteristics (γ-characteristics) are calculated from γ=(Pw/Mod)·(d Mod/d Pw). In the figure, Mod₁ denotes the value of the degree of modulation, plotted for each measured value of the read signal level in FIG. 8A, Mod₂ denotes approximate modulation characteristics (Mod characteristics) calculated from each Mod₁ value, γ₁ denotes the gamma characteristics calculated using Mod₁ and γ₂ denotes the gamma characteristics (γ-characteristics) calculated using Mod₂. A target recording power level Pw_{target} is obtained from the gamma characteristics (γ-characteristics) curve shown by γ₂ when a target γ value: γ_{target} is given.

Other related conventional techniques described in patent documents include ones disclosed in, for example, JP-A-2000-251254, JP-A-2007-141438, and JP-A-2007-226948. Described in JP-A-2000-251254 is the technique for recording information on a recording medium by repeating forcible recording in the test-recording area of the recording medium at least a desired number of times by laser beam irradiation, and after stabilizing the recording characteristics in the test-recording area, conducting an OPC operation to determine the optimum laser power. JP-A-2007-141438 describes another technique for determining the optimum recording power for an optical disc; in this conventional technique, a test pattern of the power level which is increased at desired intervals is recorded three times in accordance with the OPC algorithm for determining the optimum recording power. JP-A-2007-226948 describes the technique designed so that in an optical disc apparatus, part of the optical disc area where OPC was conducted is erased at the optimum erasing power level in order to enhance the reliability of the OPC results obtained during the next OPC. The optimum erasing power level in this case is determined by calculating, from a power-to-modulation curve, variations in the degree of modulation with respect to changes in power level and then analyzing the calculated variations in the degree of modulation. During the OPC processing following the erasure, test data in the OPC area is recorded at various power levels, and OPC processing is repeated, whereby the recorded data is read out to detect the optimum recording power level.

### SUMMARY

The techniques mentioned above with reference to FIGS. 7 and 8 of the above conventional techniques are designed to calculate, as OPC processing, the optimum recording power (OPC Power) or the optimum recording power level (OPC Power level) Po based on one time test-recording which is performed once with test-recording power, employing one of the Power Scan Write schemes in which the test-recording power increases gradually during the test recording. For this reason, when the OPC processing is conducted for a rewritable optical disc such as a CD-RW and DVD-RW, the optimum recording power derived as a result of the OPC processing will exhibit such characteristics as shown in FIG. 9, for example, and the optimum recording power (OPC Power) level Po derived will decrease significantly each time the OPC processing is repeated. For example, if the optimum recording power Po derived as a result of the first OPC processing is about 42.3 mV, the optimum recording power Po derived as a result of the second OPC processing will be about 40.95 mV, which is smaller than the value obtained during the first OPC processing by about 1.35 mV. Additionally, the optimum recording power Po derived as a result of the third OPC processing will be about 39.90 mV, which is smaller than the value obtained during the second OPC processing by about 1.05 mV. In this way, each time the OPC processing is repeated, the setting of the optimum recording power level Po will change significantly, augmenting the difference of the optimum recording power level set based on the OPC processing between the current and previous OPC processing, and resulting in the deterioration of recording power accuracy. The deterioration of recording power accuracy will also lead to that of recording quality.

According to a statement on an embodiment of the technique described in JP-A-2000-251254, the recording operation repeated at least a desired number of times refers to “DOW (Direct Overwriting) in which, prior to the OPC processing, overwriting is repeated unconditionally at least twice, preferably, 10 times or more, in all areas of the drive test zone in which the OPC processing is used, or in part of the area where an actual test-recording is conducted”. Accordingly, this conventional technique is considered to be a technique for recording information at a fixed power level before conducting the OPC processing of the scheme in which the test-recordings take place at various recording power levels. In JP-A-2007-141438, since the description of the technique concerned includes the statement that “the test for determining the optimum recording power level is repeated at least twice at different starting power settings”, it seems that this conventional technique involves repeating the OPC processing three times and thus that a relatively long time is required until the recording power level has been set. In the technique of JP-A-2007-226948, the optimum erasing power level for erasing a portion of the optical disc for which the OPC processing was conducted is calculated through the step of deriving a power-to-modulation curve, the step of calculating, from the power-to-modulation curve, variations in the degree of modulation with respect to changes in power level, and the step of determining the optimum erasing power level using the calculated modulation data. In addition, as it is stated in an embodiment of the technique of JP-A-2007-226948 that during the OPC processing, test data is recorded and then OPC processing is repeated to reproduce the recorded data in order to detect the optimum recording power level, the OPC processing itself is repeated following completion of the calculation of the optimum erasing power level, and thus a time up to the detection of the optimum recording power level is considered to correspondingly increase. Furthermore, the techniques described in JP-A-2007-141438 and JP-A-2007-226948 are not intended to suppress the significant decrease in the optimum recording power level Po due to the repetition of the OPC processing.

In view of the above situations of the conventional techniques, the present invention allows information-recording power accuracy of an optical disc apparatus to be enhanced by, while minimizing an OPC processing time required for information recording on a rewritable optical disc, reducing variations (decrements) in optimum recording power level derived each time the OPC processing is repeated.

An object of the present invention is to provide an optical disc apparatus capable of starting the information-recording operation rapidly and further improving information-recording quality of the rewritable optical disc.

The present invention is, as an aspect thereof, a technique that makes the above object achievable.

That is to say, the present invention provides an optical disc apparatus constructed so that: a disc ID of an optical disc subjected to information recording is discriminated, recording-test repetition count information appropriate for the discriminated disc ID is acquired from a strategy pre-registered in the optical disc apparatus, the number of recording test cycles to be conducted upon one specific address within a test-recording area of the optical disc is assigned using the acquired test-recording repetition count information, the assigned number of test-recording cycles are conducted, and an optimum recording power level for information recording is calculated using a read signal generated after the final test-recording. For example, modulation characteristics of the read signal generated after the final test-recording are calculated, gamma characteristics (γ-characteristics) are calculated from the modulation characteristics (Mod characteristics), and the optimum recording power level for information recording is calculated from the gamma characteristics. The optimum recording power level in the present invention means the recording power falling within a level range appropriate for constructing the invention effectively.

### BRIEF DESCRIPTION OF THE DRAWINGS

FIG. 1 is a block diagram of an optical disc apparatus constructed as an embodiment;

FIG. 2 is an explanatory diagram of a first example of an OPC processing in the optical disc apparatus of FIG. 1;

FIG. 3 is a diagram showing an example of optimum recording power characteristics obtained in the OPC processing in the optical disc apparatus of FIG. 1;

FIG. 4 is an explanatory diagram of a second example of the OPC processing in the optical disc apparatus of FIG. 1;

FIG. 5 is an explanatory diagram of a third example of the OPC processing in the optical disc apparatus of FIG. 1;

FIG. 6 is a diagram showing another example of the optimum recording power characteristics obtained in the OPC processing in the optical disc apparatus of FIG. 1;

FIG. 7 is an explanatory diagram of an OPC processing in a conventional optical disc apparatus;

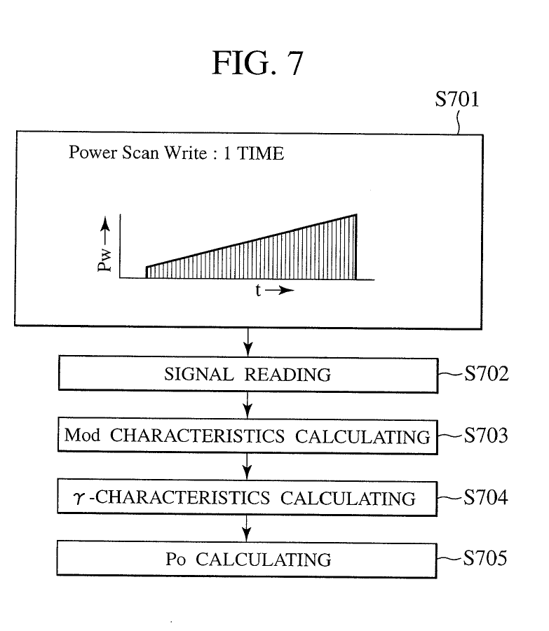

FIGS. 8A and 8B are explanatory diagrams of read signal characteristics, modulation characteristics (Mod characteristics), and gamma characteristics (γ-characteristics) obtained in the OPC processing of the conventional optical disc apparatus; and

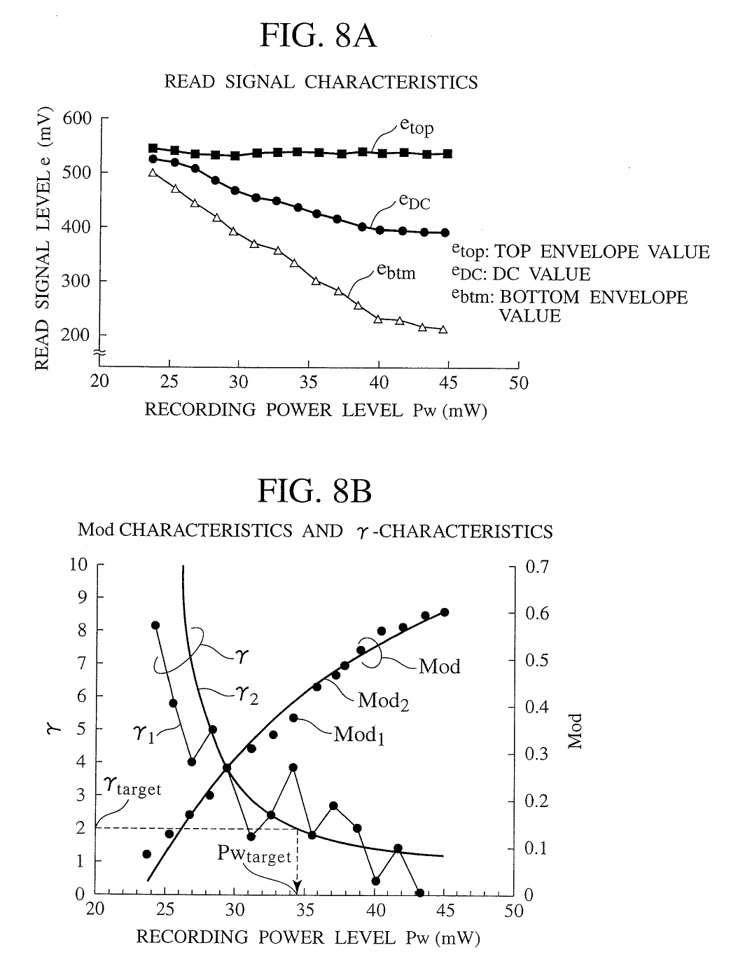

FIG. 9 is a diagram illustrating the problem to be solved.

### DETAILED DESCRIPTION OF THE PREFERRED EMBODIMENT

Hereunder, an embodiment will be described using the accompanying drawings.

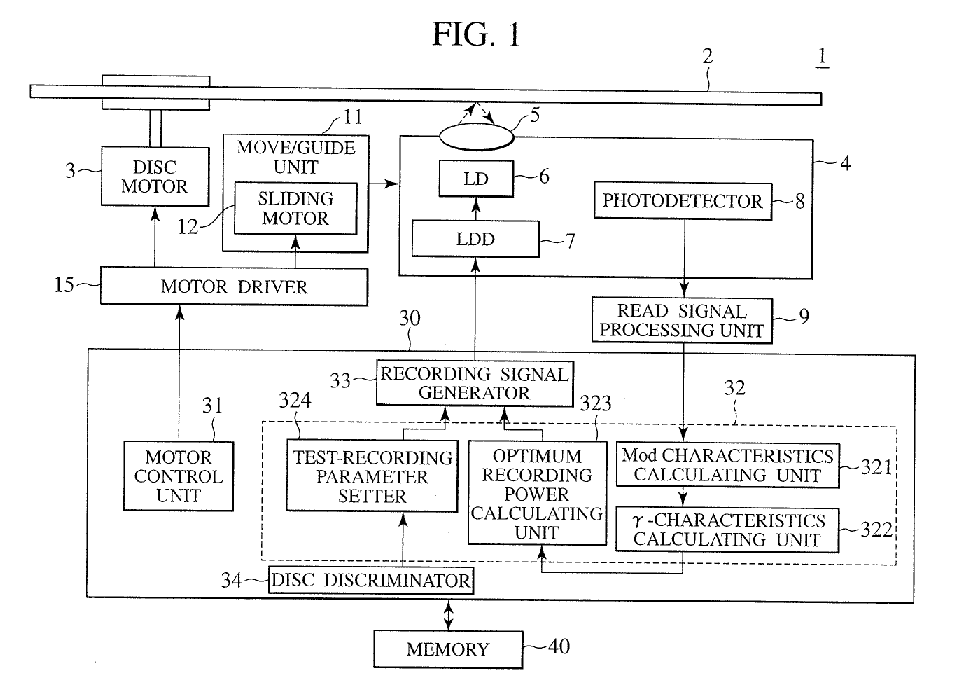

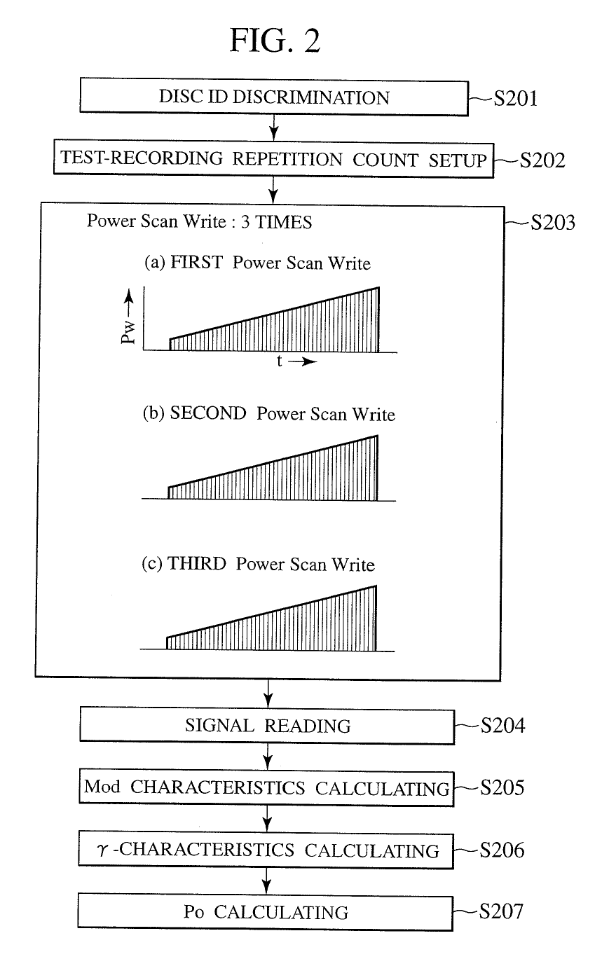

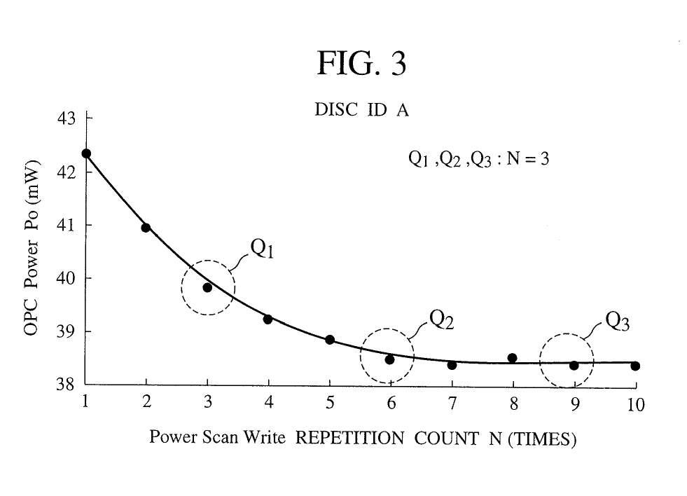

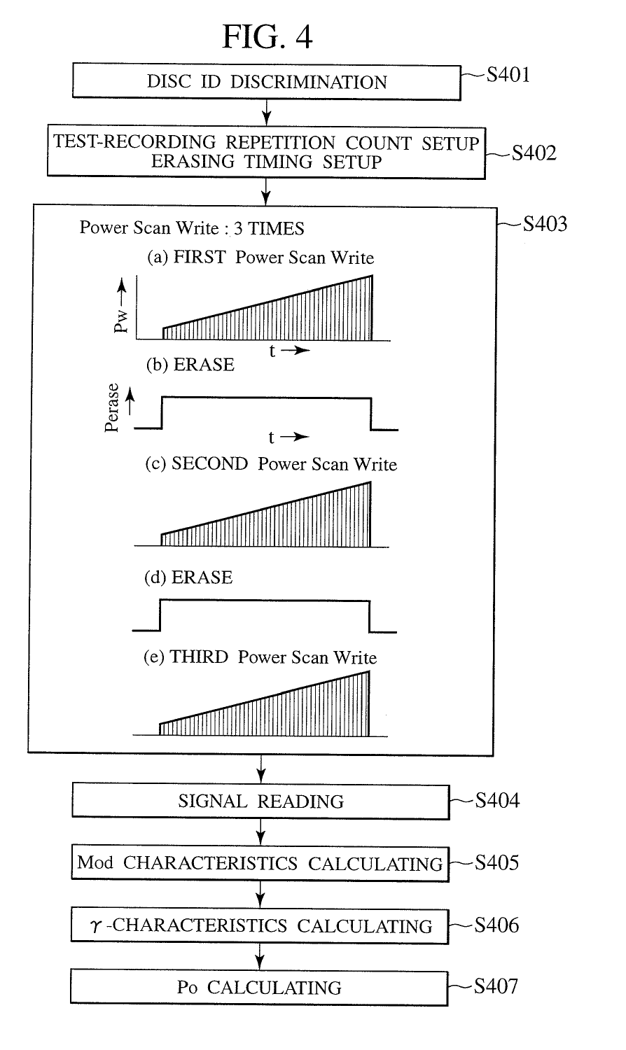

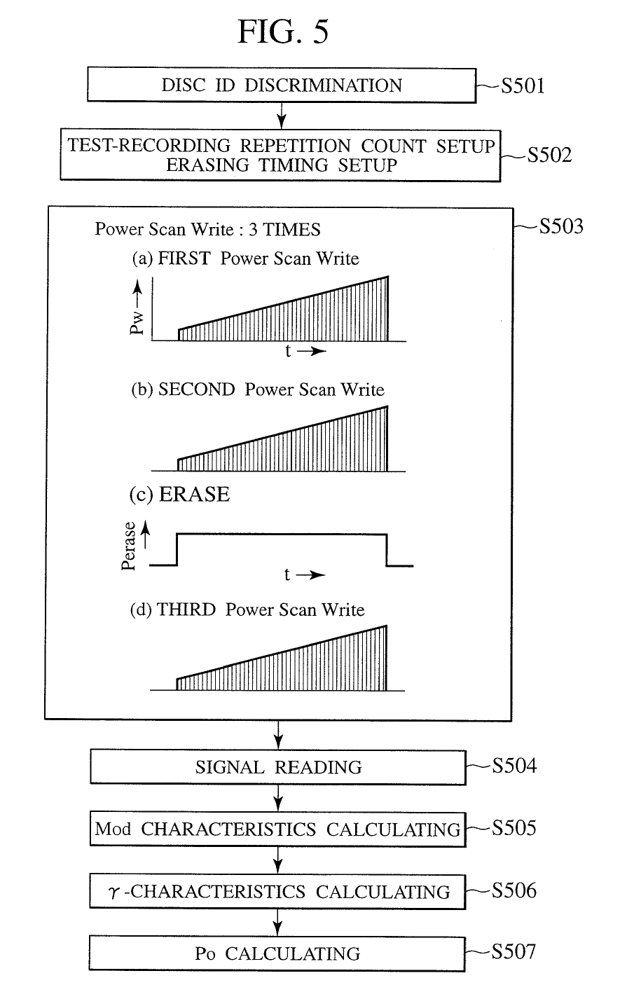

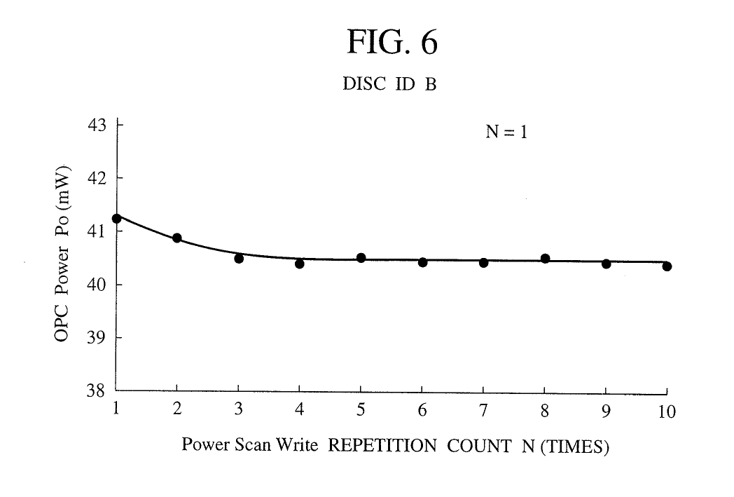

FIGS. 1 to 6 are explanatory diagrams of an optical disc apparatus as the embodiment. FIG. 1 is a block diagram of the optical disc apparatus constructed as the embodiment. FIG. 2 is an explanatory diagram of a first example of an OPC processing in the optical disc apparatus of FIG. 1. FIG. 3 is a diagram showing an example of optimum recording power (OPC Power) characteristics obtained in the OPC processing of the optical disc apparatus in FIG. 1. FIG. 4 is an explanatory diagram of a second example of the OPC processing in the optical disc apparatus of FIG. 1. FIG. 5 is an explanatory diagram of a third example of the OPC processing in the optical disc apparatus of FIG. 1. FIG. 6 is a diagram showing another example of the optimum recording power (OPC Power) characteristics obtained in the OPC processing of the optical disc apparatus of FIG. 1.

The following description of the optical disc apparatus as the embodiment assumes that the apparatus employs the OPC processing of the so-called gamma scheme in which, after a test-recording, modulation characteristics (Mod characteristics) and gamma characteristics (γ-characteristics) are calculated from a read signal resulting from the test-recording, and then optimum recording power (OPC Power) is calculated from the gamma characteristics.

Referring to FIG. 1, reference number 1 denotes the optical disc apparatus as the embodiment, 2 denotes a rewritable optical disc such as a CD-RW or DVD-RW, and 3 denotes a disc motor for rotationally driving the optical disc 2. Also, reference number 4 denotes an optical pickup, 5 denotes an objective lens, 6 denotes a laser diode that generates laser light of a desired strength level for recording or reading, and 7 denotes a laser driver for driving the laser diode 6. Additionally, reference number 8 denotes a photodetector that detects via the objective lens 5 the laser light reflected from the recording surface (disc surface) of the optical disc 2, then converts the detected laser light into an electrical signal (read signal), and outputs the signal to the next stage of the optical disc apparatus, 9 denotes a read signal processing unit for conducting a processing such as amplification or demodulation to process the read signal (i.e., the output from the photodetector 8) into an RF signal (radio frequency signal), and 11 denotes a move/guide unit constructed with elements such as a linear guide member and lead screw member (neither shown) in order to move the optical pickup 4 substantially in a radial direction of the optical disc 2. Reference number 12 denotes a sliding motor located in the slider/guide unit 11 and constructed to rotationally drive the lead screw member (not shown), and 15 denotes a motor driver for rotationally driving the disc motor 3 and the sliding motor 12. Reference number 30 denotes a system controller functioning as a control unit for controlling the entire optical disc apparatus 1, 31 denotes a motor control unit located in the system controller 30 in order to control the motor driver 15, 32 denotes a microcomputer located in the system controller 30, 321 denotes a modulation characteristics calculating unit (Mod characteristics calculating unit) constructed in the microcomputer 32 in order to calculate modulation characteristics from the read signal output from the read signal processing unit 9, 322 denotes a gamma characteristics calculating unit (γ-characteristics calculating unit) constructed in the microcomputer 32 in order to calculate gamma characteristics from the modulation characteristics calculated by the modulation characteristics calculating unit 321, and 323 denotes an optimum recording power calculating unit constructed in the microcomputer 32 in order to calculate an appropriate target recording power level (OPC Power level) for a preset target y value, based on the gamma characteristics (γ-characteristics) calculated by the gamma characteristics calculating unit 322, and further calculate from the target recording power level the optimum power level for information recording (the optimum recording power level means the recording power staying within a level range appropriate for constructing the invention effectively). Reference number 324 denotes a recording parameter setter constructed in the microcomputer 32 so that during the OPC processing, the setter assigns, on the basis of test-recording repetition count information appropriate for a disc ID of the optical disc 2 and pre-registered as a strategy in the optical disc apparatus 1, the number of test-recording cycles to be performed on one specific address within a test-recording area of the optical disc 2, assigns a recording power level using the test-recording power information corresponding to the disc ID, or when a plurality of test-recording cycles are assigned, erases the information recorded in a test-recording operation other than the final test, or assigns execution of the erasing timing, and 33 denotes a recording signal generator existing in the system controller 30 and functioning to generate a test-recording signal for input to the laser driver 7 during a test-recording phase of the OPC processing in order to activate the laser driver 7 to drive the laser diode 6 so that the test-recording power gradually changes during each test-recording period, and outputs the test-recording signal according to the number of test-recording cycles assigned from the recording parameter setter 324, or outputs a signal for erasing test-recorded data or specifying execution of the erasing timing, or during data recording, generates and outputs a recording signal for driving the laser diode 6 at the optimum recording power level (OPC Power level) calculated by the optimum recording power calculating unit 323. Reference number 34 denotes a disc discriminator existing in the system controller 30 in order to discriminate the disc ID of the optical disc 2, and 40 denotes a memory in which strategies for optical discs including the optical disc 2, OPC processing programs, OPC processing parameters, and other factors are registered (stored). An output from the optimum recording power calculating unit 323 is input to the recording signal generator 33, which then generates a recording signal for normal information recording. Again, the optimum recording power level (OPC power level) in the present embodiment means the recording power staying within a level range appropriate for constructing the invention effectively.

The modulation characteristics calculating unit 321, gamma characteristics calculating unit 322, and optimum recording power calculating unit 323 in the system controller 30 as a control unit constitute a reading circuit control unit for test-recording in the OPC processing. The disc discriminator 34, the test-recording parameter setter 324, and the recording signal generator 33 constitute a recording circuit control unit for test-recording in the OPC processing.

During the OPC processing, when a top envelope value of a level of the read signal for test-recording, output from the read signal processing unit 9, is expressed as eₜₒₚ and a bottom envelope value of the read signal level is expressed as e_{btm}, the modulation characteristics calculating unit 321 calculates the modulation characteristics (Mod characteristics) of the read signal using the following expression:

Degree of modulation Mod=(eₜₒₚ−e_{btm})/eₜₒₚ (expression 1)

The modulation characteristics calculating unit 321 also derives approximate modulation characteristics from the above calculated modulation characteristics by calculating operations.

During the OPC processing, when a test-recording power level is expressed as Pw and the degree of modulation of the read signal corresponding to test-recording at the test-recording power level Pw, the gamma characteristics calculating unit 322 calculates gamma characteristics using the following expression:

γ=(Pw/Mod)·(d Mod/d Pw) (expression 2)

As the degree of modulation (Mod) in the expression 2, the calculation results of the expression 1 are used.

During the OPC processing, when the optimum recording power calculating unit 323 calculates a target recording power level Pw_{target}, the calculating unit 323 reads out a target γ-value γ_{target} pre-registered as one element of strategic data in the memory 40, and then calculates the target recording power level Pw_{target} that matches the target γ-value γ_{target} on the gamma characteristics curve obtained. In addition, when the optimum recording power calculating unit 323 also calculates the optimum recording power (OPC Power) level Po, the calculating unit 323 multiplies the above-obtained target recording power level Pw_{target} by a coefficient that indicates a possible ratio between the optimum recording power level Po and the target recording power level Pw_{target}, the coefficient being ρ of a fixed value pre-registered (prestored) as one element of the strategic data in the memory 40. Briefly, the optimum recording power (OPC Power) level Po is calculated as follows:

Po=ρ·Pw_{target} (expression 3)

During the OPC processing, the test-recording parameter setter 324 reads out, from the strategy pre-registered (prestored) in the memory 40, the test-recording parameter information matching the disc ID discriminated by the disc discriminator 34 (i.e., test-recording count information), test-recording power information, and when a plurality of recording test cycles are preassigned, the information specifying whether to erase test-recorded information and in what timing to conduct the erasure, and then assigns the three sets of information. In this case, the present embodiment assumes that test-recording parameter information matching the disc IDs of plural kinds of optical discs, for example, is prestored as a table in the memory 40. During the OPC processing, when a plurality of recording test cycles are preassigned, the test-recording parameter setter 324 assigns a test-recording parameter specifying that an address position of a line where information that was recorded during a first recording test is erased should be used as a second test-recording position of a line following that line. During the OPC processing, when a plurality of recording test cycles are preassigned, the test-recording parameter setter 324 also assigns a test-recording parameter that specifies erasing any information that has been recorded during a recording test immediately preceding the final test, and a test-recording parameter that specifies conducting the final recording test at the address position within the test recording area of the optical disc 2 where the information has been erased. In addition, during the OPC processing, when a plurality of recording test cycles are preassigned, the test-recording parameter setter 324 transmits an instruction signal to the motor control unit 31 and controls rotation of the sliding motor 12 of the slider/guide unit 11. The rotation of the sliding motor 12 controls rotation of the lead screw (not shown), then controlling the moving position of the optical pickup 4, and repeatedly recording the test-recording signal a plurality of times at one specific address position within the test-recording area.

The recording signal generator 33 generates a test-recording signal for test-recording of a power scan scheme in which the test-recording power level changes during the test-recording period (hereinafter, test-recording of the power scan scheme is referred to as the Power Scan Write). The following description assumes that the Power Scan Write in which the test-recording power level changes gradually is conducted as test-recording.

In the above configuration, the optical disc apparatus 1 conducts the OPC processing before recording information (data) on the optical disc 2. During the OPC processing, the disc discriminator 34 first discriminates the disc ID of the optical disc 2 and outputs a discrimination result signal to the test-recording parameter setter 324. The test-recording parameter setter 324 then reads out the test-recording parameter information matching the disc ID discriminated by the disc discriminator 34, from the strategy pre-registered (prestored) in the memory 40, and assigns the test-recording parameter information. The test-recording parameter information includes, for example, information on the number of test-recording cycles conducted upon one specific address within the test-recording area of the optical disc 2 (i.e., test-recording repetition count information), and when a plurality of test-recording cycles are actually preassigned, whether to erase test-recorded information and in what timing to conduct the erasure. The recording signal generator 33 generates the test-recording signal for conducting the Power Scan Write, and outputs the test-recording signal in accordance with the test-recording parameter information assigned from the test-recording parameter setter 324. The recording signal generator 33 also generates and outputs an instruction signal that specifies erasing test-recorded data if a plurality of test-recording cycles are preassigned, and an instruction signal that specifies the execution timing of the erasure. The test-recording signal and the instruction signals are input to the laser driver 7. The laser driver 7 generates a driving signal based upon the test-recording signal and the instruction signals, and the driving signal drives the laser diode 6 to generate laser light. At this time, the motor control unit 31 receives from the test-recording parameter setter 324 the instruction signal specifying the control of the rotation of the sliding motor 12, and uses the received instruction signal to control the rotation of the sliding motor 12 via the motor driver 15 and move the optical pickup 4, or the objective lens 5, to a position corresponding to a desired address position in the test-recording area of the optical disc 2 is to be irradiated with the generated laser light. Test-recording and erasure from the address position are conducted by the laser light irradiation. If a plurality of recording test cycles are preassigned, the motor control unit 31 controls the position of the objective lens 5 so that test-recording at the same address in the test-recording area is repeated a plurality of times. For test-recorded data erasure, the position of the objective lens 5 is controlled likewise. After test-recording (Power Scan Write), the photodetector 8 of the optical pickup 4 detects the laser light reflected from the address corresponding to the test-recorded data, and converts the detected laser light into an electrical signal. The read signal processing unit 9 conducts amplification, demodulation, and/or other signal processing, in response to a read signal output from the photodetector 8. After a plurality of test-recording cycles, signal processing is required only for a read signal generated after the final test-recording. The modulation characteristics calculating unit 321 uses foregoing expression 1 to calculate the modulation characteristics of the read signal output from the read signal processing unit 9 after the final test-recording. The gamma characteristics calculating unit 322 uses foregoing expression 2 to calculate gamma characteristics based upon the modulation characteristics calculated by the modulation characteristics calculating unit 321. The optimum recording power calculating unit 323 calculates a target recording power level appropriate for a preset target γ-value, based upon the gamma characteristics calculated by the gamma characteristics calculating unit 322, and then uses foregoing expression 3 to calculate an optimum information-recording power level, that is, an optimum power value within an optimum level range, from the target recording power level. Thus, the optimum recording power calculating unit 323 forms an appropriate control signal according to the above calculation results, outputs the control signal to the recording signal generator 33, and controls the recording signal generator 33. This control completes the OPC processing. The recording signal generator 33 is controlled in accordance with the above control signal, and generates a recording signal for normal information recording.

After the OPC processing, the laser driver 7 is controlled by the normal information-recording signal, and drives the laser diode 6 to generate laser light of the above-assigned optimum recording power level. Normal information recording (data recording) on the optical disc 2 is conducted at the recording power level of the laser light generated by the driving of the laser diode 6.

The following description uses the same reference numbers and symbols as used for the constituent elements of the optical disc apparatus in the configuration of FIG. 1.

FIG. 2 is an explanatory diagram of a first example of an OPC processing in the optical disc apparatus 1 of FIG. 1. In the first example, the Power Scan Write as test-recording is repeated three times and no test-recorded data is erased during the Power Scan Writes.

FIG. 2 shows a flow of the OPC processing in the optical disc apparatus 1.

In FIG. 2:

(1) In step S201, the disc discriminator 34 in the system controller 30 functioning as a control unit discriminates the disc ID of the optical disc 2 on which information is to be recorded.

(2) In step S202, the test-recording parameter setter 324 in the system controller 30 reads out a recording-test repetition count of 3 times as a test-recording parameter matching the discriminated disc ID, from the strategy pre-registered (prestored) in the memory 40, and assigns the test-recording parameter.

(3) In step S202, the recording signal generator 33 in the system controller 30 generates a recording test signal for repeating the Power Scan Write three times in accordance with the information assigned from the test-recording parameter setter 324, and outputs the test-recording signal to the laser driver 7. In response to the test-recording signal, the laser driver 7 drives the laser diode 6 to generate laser light. In step S203, one specific address in the test-recording area of the optical disc 2 is irradiated with the laser light through the objective lens 5, whereby the Power Scan Write on the same address is repeated three times as test-recording. At this time, the objective lens 5 is position-controlled via the motor control unit 31 and the move/guide unit 11 to ensure that the Power Scan Write is conducted upon the same address three times.

(4) In step S204, the photodetector 8 and the read signal processing unit 9 read the signal that has been used for test-recording. That is to say, the photodetector 8 detects the laser light reflected from the address position at which information has been test-recorded, and converts the reflected light into electrical signal form. The read signal processing unit 9 conducts amplification, demodulation, and/or other signal processing, in response to the read signal output from the photodetector 8 after the third Power Scan Write that is the final test-recording.

(5) In step S205, the modulation characteristics calculating unit 321 in the microcomputer 32 of the system controller 30 uses foregoing expression 1 to calculate the modulation characteristics of the read signal output from the read signal processing unit 9 after the third Power Scan Write.

(6) In step S206, the gamma characteristics calculating unit 322 in the microcomputer 32 of the system controller 30 uses foregoing expression 2 to calculate gamma characteristics based upon the modulation characteristics calculated by the modulation characteristics calculating unit 321.

(7) In step S207, the optimum recording power calculating unit 323 in the microcomputer 32 of the system controller 30 calculates a target recording power level appropriate for a preset target γ-value, based upon the gamma characteristics calculated by the gamma characteristics calculating unit 322, and then uses foregoing expression 3 to calculate the optimum recording power (OPC Power) level Po from the target recording power level.

The system controller 30 conducts the successive operations of above steps S201 to S207 by executing associated operation sequences in accordance with a program pre-registered in the memory 40.

FIG. 3 is a diagram showing an example of optimum recording power characteristics obtained in the OPC processing of FIG. 2 for the optical disc 2 in the optical disc apparatus 1 of FIG. 1 (for the sake of convenience, the disc ID of the optical disc is taken as A).

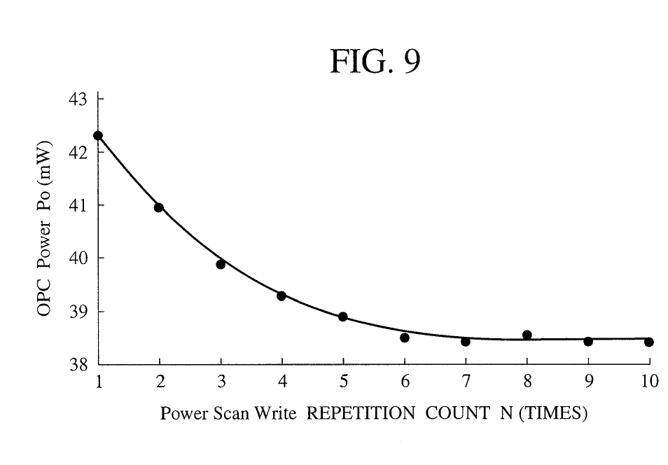

In FIG. 3, points Q₁, Q₂ and Q₃, each denotes the position of the optimum recording power (OPC Power) level Po in an OPC Power characteristics curve, the optimum recording power (OPC Power) level Po being obtained from a read signal after the Power Scan Writes are performed three times. Specifically, Q₁ represents the position of the optimum recording power (OPC Power) level Po obtained from a read signal after the Power Scan Writes are performed three times as the first OPC processing, that is, Q₁ represents the position of the optimum recording power (OPC Power) level Po obtained from a read signal after the third Power Scan Write is performed. Q₂ represents the position of the optimum recording power (OPC Power) level Po obtained from a read signal after the Power Scan Writes are performed three times as the second OPC processing, that is, Q₂ represents the position of the optimum recording power (OPC Power) level Po obtained from a read signal after the sixth Power Scan Write is performed. Q₃ represents the position of the optimum recording power (OPC Power) level Po obtained from a read signal after the Power Scan Writes are performed three times as the third OPC processing, that is, Q₃ represents the position of the optimum recording power (OPC Power) level Po obtained from a read signal after the ninth Power Scan Write is performed. If the OPC processing takes place for each Power Scan Write, the same characteristics of the optimum recording power (OPC Power) level Po as those of FIG. 9 will be obtained in the characteristics curve of FIG. 3.

In the characteristics curve of FIG. 3, if the OPC processing shown in FIG. 2 takes place, the optimum recording power level Po derived from results of the first OPC processing will be about 39.9 mV (Q₁ position). Similarly, the optimum recording power (OPC Power) level Po derived from results of the second OPC processing will be about 38.5 mV (Q₂ position) and the optimum recording power (OPC Power) level Po derived from results of the third OPC processing will be about 38.4 mV (Q₃ position). These indicate extremely small variations in the optimum recording power level Po derived from the results of the second and subsequent OPC processes. Accordingly, differences between settings of the recording power level for each OPC processing become small and accuracy of the recording power level improves as well. The improvement of recording power accuracy leads to improvement and stabilization of recording quality.

FIG. 4 is an explanatory diagram of a second example of the OPC processing in the optical disc apparatus of FIG. 1. In the second example, the Power Scan Write as test-recording is repeated three times, and test-recorded data is erased between the first and second Power Scan Writes and between the second and third Power Scan Writes.

FIG. 4 shows a flow of the OPC processing in the optical disc apparatus 1.

In FIG. 4:

(1) In step S401, the disc discriminator 34 in the system controller functioning as a control unit discriminates the disc ID of the optical disc 2 on which information is to be recorded.

(2) In step S402, the test-recording parameter setter 324 in the system controller 30 reads out, from the strategy pre-registered (prestored) in the memory 40, two kinds of test-recording parameter information matching the discriminated disc ID, that is, a recording-test repetition count of 3 times and execution timing in which test-recorded data is to be erased between the first and second Power Scan Writes and between the second and third Power Scan Writes, and assigns the test-recording parameter information.

(3) In step S402, the recording signal generator 33 in the system controller 30 generates a recording test signal for repeating the Power Scan Write three times, an instruction signal that specifies erasing test-recorded data, and an instruction signal that specifies the execution timing of the erasure, in accordance with the above two kinds of information assigned from the test-recording parameter setter 324, and outputs the test-recording signal and the instruction signals to the laser driver 7. In response to the test-recording signal and instruction signals output from the recording signal generator 33, the laser driver 7 drives the laser diode 6 to generate laser light for test-recording. In step S403, one specific address in the test-recording area of the optical disc 2 is irradiated with the laser light through the objective lens 5, whereby the Power Scan Write as test-recording is repeated three times at the same address position and the erasure is repeated twice thereat. At this time, the objective lens 5 is position-controlled via the motor control unit 31 and the move/guide unit 11 to ensure that the Power Scan Write and the erasure are conducted upon the same address three times and twice, respectively.

(4) In step S404, the photodetector 8 and the read signal processing unit 9 read the signal that has been used for test-recording. That is to say, the photodetector 8 detects the laser light reflected from the address position at which information has been test-recorded, and converts the reflected light into electrical signal form. The read signal processing unit 9 conducts amplification, demodulation, and/or other signal processing, in response to the read signal output from the photodetector 8 after the third Power Scan Write.

(5) In step S405, the modulation characteristics calculating unit 321 in the microcomputer 32 of the system controller 30 uses foregoing expression 1 to calculate the modulation characteristics of the read signal output from the read signal processing unit 9 after the third Power Scan Write.

(6) In step S406, the gamma characteristics calculating unit 322 in the microcomputer 32 of the system controller 30 uses foregoing expression 2 to calculate gamma characteristics based upon the modulation characteristics calculated by the modulation characteristics calculating unit 321.

(7) In step S407, the optimum recording power calculating unit 323 in the microcomputer 32 of the system controller 30 calculates a target recording power level appropriate for a preset target γ-value, based upon the gamma characteristics calculated by the gamma characteristics calculating unit 322, and then uses foregoing expression 3 to calculate the optimum recording power (OPC Power) level Po from the target recording power level.

The system controller 30 conducts the successive operations of above steps S401 to S407 by executing associated operation sequences in accordance with a program pre-registered in the memory 40.

FIG. 5 is an explanatory diagram of a third example of an OPC processing in the optical disc apparatus 1 of FIG. 1. In the third example, the Power Scan Write as test-recording is repeated three times, and test-recorded data is erased only between the second Power Scan Write and the third Power Scan Write.

FIG. 5 shows a flow of the OPC processing in the optical disc apparatus 1.

In FIG. 5:

(1) In step S501, the disc discriminator 34 in the system controller 30 functioning as a control unit discriminates the disc ID of the optical disc 2 on which information is to be recorded.

(2) In step S502, the test-recording parameter setter 324 in the system controller 30 reads out, from the strategy pre-registered (prestored) in the memory 40, two kinds of test-recording parameter information matching the discriminated disc ID, that is, a test-recording repetition count of 3 times and execution timing in which test-recorded data is to be erased between the second and third Power Scan Writes, and assigns the test-recording parameters.

(3) In step S502, the recording signal generator 33 in the system controller 30 generates a test-recording signal for repeating the Power Scan Write three times, an instruction signal that specifies erasing test-recorded data, and an instruction signal that specifies the execution timing of the erasure, in accordance with the above two kinds of information assigned from the test-recording parameter setter 324, and outputs the test-recording signal and the instruction signals to the laser driver 7. In response to the test-recording signal and instruction signals output from the recording signal generator 33, the laser driver 7 drives the laser diode 6 to generate laser light for test-recording. In step S503, the laser light is applied to one specific address in the test-recording area of the optical disc 2 through the objective lens 5, whereby the Power Scan Write as test-recording is repeated three times at the same address position and the erasure is repeated once thereat. At this time, the objective lens 5 is position-controlled via the motor control unit 31 and the move/guide unit 11 to ensure that the Power Scan Write is conducted three times, and the erasure once, upon the same address.

(4) In step S504, the photodetector 8 and the read signal processing unit 9 read the signal that has been used for test-recording. That is to say, the photodetector 8 detects the laser light reflected from the address position at which information has been test-recorded, and converts the reflected light into electrical signal form. The read signal processing unit 9 conducts amplification, demodulation, and/or other signal processing, in response to the read signal output from the photodetector 8 after the third Power Scan Write.

(5) In step S505, the modulation characteristics calculating unit 321 in the microcomputer 32 of the system controller 30 uses foregoing expression 1 to calculate the modulation characteristics of the read signal output from the read signal processing unit 9 after the third Power Scan Write.

(6) In step S506, the gamma characteristics calculating unit 322 in the microcomputer 32 of the system controller 30 uses foregoing expression 2 to calculate gamma characteristics based upon the modulation characteristics calculated by the modulation characteristics calculating unit 321.

(7) In step S507, the optimum recording power calculating unit 323 in the microcomputer 32 of the system controller 30 calculates a target recording power level appropriate for a preset target γ-value, based upon the gamma characteristics calculated by the gamma characteristics calculating unit 322, and then uses foregoing expression 3 to calculate the optimum recording power level Po from the target recording power level.

The system controller 30 conducts the successive operations of above steps S501 to S507 by executing associated operation sequences in accordance with a program pre-registered in the memory 40.

FIG. 6 is a diagram showing another example of optimum recording power characteristics obtained in the OPC processing of the optical disc apparatus 1 in FIG. 1.

Optical discs of the rewritable type may include those whose disc IDs are taken as B for the sake of convenience, as with the optical disc having the characteristics shown in FIG. 6. Referring to the characteristics in FIG. 6, unlike those of FIG. 3, variations in the optimum recording power level Po obtained are quite insignificant, even when an individual OPC processing is conducted for each test-recording. For the optical disc having these characteristics in the optical disc apparatus 1, the test-recording parameter setter 324 in the microcomputer 32 assigns a test-recording repetition count of 1 time as a test-recording parameter matching the disc ID discriminated by the disc discriminator 34. That is to say, the test-recording repetition count for the disc ID B is pre-registered (prestored) as strategic information in the memory 40.

The optical disc apparatus 1 as the embodiment allows information recording to be started rapidly. In addition, for information recording on a rewritable optical disc, the number of test-recordings during the OPC processing can be changed according to the disc ID of that optical disc, so if the optical disc undergoes significant variations in the optimum recording power level determined by the OPC processing results during one test-recording, these variations in the optimum recording power level can be reduced by repeating the test-recording a plurality of times automatically. This allows the improvement of recording power accuracy and thus the improvement and stabilization of recording quality.

In the embodiment described above, the Power Scan Write as test-recording is repeated three times during the OPC processing involving more than one test-recording cycle, as in FIGS. 2, 4 and 5. The present invention, however, is not limited to or by the description and the number of test-recording cycles may be two or, if the processing time stays within its allowable range, four or more. In addition, while the test-recording scheme that gradually increases the test-recording power level is employed as the Power Scan Write in the embodiment described above, the present invention is not limited to or by the description and may employ a test-recording scheme that reduces the recording power level gradually or scrambles the recording power level. Furthermore, although the embodiment described above relates to the OPC processing of the so-called gamma scheme in which, after test-recording, modulation characteristics and gamma characteristics are derived from the resulting read signal and then the optimum recording power level is calculated from the gamma characteristics, the kind of processing that follows test-recording is not limited to the description of the embodiment and the OPC processing may be, for example, a beta scheme in which test-recording is followed by calculation of an optimum recording power level based upon beta characteristics, or a kappa scheme in which test-recording is followed by calculation of an optimum recording power level based upon kappa characteristics.

According to the optical disc apparatus as the embodiment, information recording in the optical disc apparatus can be started rapidly. In addition, during information (data) recording on a rewritable optical disc, the accuracy of the recording power level can be improved, which in turn allows recording quality to be improved and stabilized.

In addition to the above embodiment, the present invention can be implemented in other forms without departing from the spirit or essential features and characteristics of the invention. Therefore, the above embodiment is only shown as an example of the present invention, and is therefore not to be interpreted restrictively. The scope of the present invention is shown in the form of the appended claims. Furthermore, all modifications and changes belonging to equivalents of the scope of the present invention stay within the scope thereof.

What is claimed is:

1. An optical disc apparatus for recording information by applying laser light to an optical disc at a recording power level based upon test-recording, the apparatus comprising:
a laser diode for generating the laser light;
a laser driver for driving the laser diode; and
a control unit constructed to discriminate a disc ID of the optical disc, then assign, in accordance with test-recording repetition count information pre-registered as strategic information in the optical disc apparatus in association with the disc ID, the number of test-recordings to be conducted upon one specific address within a test-recording area of the optical disc, and after generating an appropriate test-recording signal for the assigned number of test-recordings, output the signal to the laser driver repeatedly according to the assigned number of test-recordings, the control unit being further constructed to calculate a recording power level for information recording, based upon a read signal generated after the final test-recording of the assigned number of test-recordings.

2. An optical disc apparatus for recording information by applying laser light to an optical disc at a recording power level based upon test-recording, the apparatus comprising:
a laser diode for generating the laser light;
a laser driver for driving the laser diode;
a disc discriminator for discriminating a disc ID of the optical disc;
a test-recording parameter setter for assigning, in accordance with test-recording repetition count information pre-registered as strategic information in the optical disc apparatus in association with the discriminated disc ID, the number of test-recordings to be conducted upon one specific address within a test-recording area of the optical disc;
a recording signal generator which, prior to test-recording, generates a test-recording signal to be input to the laser driver, and then outputs the signal thereto repeatedly according to the number of test-recordings assigned from the test-recording parameter setter; and
a calculating unit for calculating a recording power level for information recording, based upon a read signal generated after the final test-recording of the assigned number of test-recordings.

3. An optical disc apparatus for recording information by applying laser light to an optical disc at a recording power level based upon test-recording, the apparatus comprising:
a laser diode for generating the laser light;
a laser driver for driving the laser diode;
a disc discriminator for discriminating a disc ID of the optical disc;
a test-recording parameter setter for assigning, in accordance with test-recording repetition count information pre-registered as strategic information in the optical disc apparatus in association with the discriminated disc ID, the number of test-recordings to be conducted upon one specific address within a test-recording area of the optical disc;
a recording signal generator which, prior to test-recording, generates, as a test-recording signal to be input to the laser driver, a signal for activating the laser driver to drive the laser diode such that a test-recording power level will change during each test-recording period, and then outputs the generated signal repeatedly according to the number of test-recordings assigned from the test-recording parameter setter;
a modulation characteristics calculating unit for calculating modulation characteristics of a read signal generated after the final test-recording of the assigned number of test-recordings;
a gamma characteristics calculating unit for calculating gamma characteristics from the calculated modulation characteristics; and
an optimum recording power calculating unit which, in accordance with the calculated gamma characteristics, derives a target recording power level appropriate for a target gamma value pre-registered as a strategic value in the optical disc apparatus, and further calculates an optimum information-recording power level from the target recording power level.

4. The optical disc apparatus according to claim 2, wherein:
the test-recording parameter setter is constructed such that when a plurality of test-recording cycles are preassigned, the test-recording parameter setter assigns a test-recording parameter specifying that an address position of a line where information that was recorded during a first test-recording is erased should be used as a second test-recording position of a line following that line.

5. The optical disc apparatus according to claim 3, wherein:
the test-recording parameter setter is constructed such that when a plurality of test-recording cycles are preassigned, the test-recording parameter setter assigns a test-recording parameter specifying that an address position of a line where information that was recorded during a first test-recording is erased should be used as a second test-recording position of a line following that line.

6. The optical disc apparatus according to claim 2, wherein:
the test-recording parameter setter is constructed such that when a plurality of test-recording cycles are preassigned, the test-recording parameter setter assigns a test-recording parameter that specifies erasing any information that has been recorded during a test-recording immediately preceding the final test-recording, and a test-recording parameter that specifies conducting the final test-recording at the address position within the test-recording area of the optical disc where the information has been erased.

7. The optical disc apparatus according to claim 2, wherein:
the test-recording parameter setter is constructed such that when a plurality of test-recording cycles are preassigned, the test-recording parameter setter assigns a test-recording parameter that specifies erasing any information that has been recorded during a test-recording immediately preceding the final test-recording, and a test-recording parameter that specifies conducting the final test-recording at the address position within the test-recording area of the optical disc where the information has been erased.

8. An information recording method for an optical disc apparatus for recording information by applying laser light to an optical disc at a recording power level based upon test-recording, the method comprising:
a first step of discriminating a disc ID of the optical disc;
a second step of deriving appropriate test-recording repetition count information for the discriminated disc ID, from a strategy pre-registered in the optical disc apparatus, and then using the derived test-recording repetition count information to assign the number of test-recordings to be conducted upon one specific address within a test-recording area of the optical disc;
a third step of generating a test-recording signal repeatedly according to the assigned number of test-recordings and then recording information upon the assigned address within the test-recording area of the optical disc; and
a fourth step of calculating a recording power level for information recording, based upon a read signal generated after the final test-recording of the assigned number of test-recordings.

9. An information recording method for an optical disc apparatus for recording information by applying laser light to an optical disc at a recording power level based upon test-recording, the method comprising:
a first step of discriminating a disc ID of the optical disc;
a second step of deriving appropriate test-recording repetition count information for the discriminated disc ID, from a strategy pre-registered in the optical disc apparatus, and then using the derived test-recording repetition count information to assign the number of test-recordings to be conducted upon one specific address within a test-recording area of the optical disc;
a third step of generating a test-recording signal to change a test-recording power level during each test-recording period, then generating laser light based upon the generated test-recording signal, and recording information upon the assigned address within the test-recording area of the optical disc;
a fourth step of calculating modulation characteristics of a read signal generated after the final test-recording of the assigned number of test-recordings;
a fifth step of calculating gamma characteristics from the modulation characteristics; and
a sixth step of deriving in accordance with the calculated gamma characteristics a target recording power level appropriate for a target gamma value pre-registered as a strategic value in the optical disc apparatus, and further calculating an optimum recording power level from the target recording power level.

10. The information recording method according to claim 8, wherein:
in the second step, when a plurality of test-recordings are preassigned, information recorded on a line during a first test-recording is erased before a second test-recording on a following line takes place.

11. The information recording method according to claim 9, wherein:
in the second step, when a plurality of test-recordings are preassigned, information recorded on a line during a first test-recording is erased before a second test-recording on a following line takes place.

12. The information recording method according to claim 8, wherein:
in the second step, when a plurality of test-recordings are preassigned, erasing any information recorded during a test-recording immediately preceding the final test-recording, and conducting the final test-recording at an address position from which the information has been erased are assigned as test-recording parameters.

13. The information recording method according to claim 9, wherein:
in the second step, when a plurality of recording tests are preassigned, erasing any information recorded during a test-recording immediately preceding the final test-recording, and conducting the final test-recording at an address from which the information has been erased are assigned as test-recording parameters.

14. An optical disc apparatus for recording information therein by applying laser light to an optical disc, the apparatus comprising:
a laser diode for emitting the laser light;
a laser driver for driving the laser diode;
a control unit adapted to assign an optimum recording power level by changing a recording power level and then repeating a Power Scan Write a plurality of times in order to apply the laser light to a test-recording area of the optical disc, the laser light being emitted from the laser diode; and
a recording unit for recording information on the optical disc on the basis of the optimum recording power level assigned from the control unit.

15. The optical disc apparatus according to claim 14, wherein:
the control unit is constructed to erase data from the test recording area of the optical disc at least once during the plurality of Power Scan Writes.
